(19) United States
(12) Patent Application Publication
(10) Pub. No.: US 2018/0206446 A1
(43) Pub. Date: Jul. 26, 2018

(54) Pet Transporter Container

(71) Applicants: Jonathan Mirsky, New York, NY (US); Anjall Kalyani, Pacifica, CA (US)

(72) Inventors: Jonathan Mirsky, New York, NY (US); Anjall Kalyani, Pacifica, CA (US)

(21) Appl. No.: 15/799,652

(22) Filed: Oct. 31, 2017

Related U.S. Application Data
(60) Provisional application No. 62/415,472, filed on Oct. 31, 2016.

(51) Int. Cl. A01K 1/02

(52) U.S. Cl. CPC A01K 1/0254; A01K 1/0272

(57) ABSTRACT

Pet carriers with at least one access portal that allows a pet owner to extend a hand into the pet carrier, but prevents the pet from exiting the pet carrier.

### I. CROSS REFERENCE TO RELATED APPLICATIONS

This application claims the benefit of U.S. Provisional Application No. 62/415,472, filed Oct. 31, 2016.

### II. FIELD OF THE INVENTION

The present invention relates generally to pet carriers. More specifically, the present invention relates to pet carriers with at least one access portal that allows a pet owner to extend a hand into the pet carrier, but prevents the pet from exiting the pet carrier.

### III. BACKGROUND

Pet carriers of varying sizes, shapes, and designs are currently available. Some existing carrier designs include, for example, plastic, hard-shell boxes and large tote bags. Examples of pet carriers are described in U.S. Pat. Nos. 6,523,499, 5,931,120, and 3,547,079.

Although pet carriers may be used as kennels for animals, they are typically used to transport animals from point to point in private vehicles or public transportation vehicles, such as planes, buses, and trains.

Animals are sometimes kept in pet carriers for extended periods of time. When transporting an animal in a private vehicle, the pet owner may choose to keep the animal in the pet carrier if the animal has a tendency to wander about the vehicle. An unrestrained animal may lodge itself in hard to reach or unsafe places, or distract the operator of the vehicle. When traveling in a public transportation vehicle, for the safety of the other passengers and for the safety of the animal, the pet owner may be required to keep the animal in the pet carrier for the duration of the trip. In addition, at certain destinations, such as a veterinarian's office, the pet owner may be required to keep the animal in the pet carrier even after arriving.

Being confined in a pet carrier, even for a short duration, can be a disquieting experience for many animals. Particularly on long trips, animals can become anxious and unsettled within the pet carrier. Often, however, the reassuring touch of the pet owner's hand can calm the animal. As a result, pet owners often desire to insert a hand into the pet carrier to provide assurance to the animal. In addition to calming the animal, a pet owner may also desire to insert a hand into the pet carrier to feed the animal or arrange other items in the pet carrier, such as an animal toy or blanket.

Prior art pet carriers generally include access doors that provide access to the interior space of the carriers to allow the pet owner to place the animal into, and remove the animal from, the pet carrier. Typical access doors include doors composed of rigid wire crossed bars, or flap-covered openings secured by a zipper. Such access doors allow the pet owner to insert their hand into the pet carrier. When such access doors are opened to allow access to the interior of the carrier, however, they may also permit the animal to escape from the pet carrier. Depending on the animal's surroundings, an escaped pet could pose a hazard to itself, other animals, or persons in the immediate vicinity. For example, in a car, an unrestrained animal could distract the driver and cause a collision. In a veterinarian's office, an unrestrained animal could come into contact with, and potentially injure other animals, or be injured by other animals. In an open location, the pet could escape from the area and desert the pet owner.

In addition to an access door, many pet carriers also have small holes in the sides of the carrier. The small holes are generally designed to provide ventilation for the animal and only provide limited access to the interior of the pet carrier. Such holes are generally only large enough to allow a pet owner to insert one or two fingers into the carrier. Accordingly, access to the interior of the pet carrier through the ventilation holes is usually quite limited. Oftentimes, if the animal is positioned away from one side of the carrier, the pet owner will not be able to reach the animal through the ventilation holes on that side.

Providing an open, unconstrained hole in the exterior of a pet carrier which is large enough to allow a pet owner to insert a hand into the pet carrier, but also small enough to prevent an animal from escaping, is not a practical option. Most pet carriers are intended to be used for animals in a wide range of shapes and sizes. Moreover, the size of a given animal will change as it ages from new-born to adult. Therefore, a portal that might be small enough to prevent one animal from escaping might be large enough to allow another animal, or the same animal earlier in its life cycle, to escape from the carrier. In addition, because animals, and particularly cats, can squeeze through small holes, an open hole in a pet carrier intended for pets of various sizes would have to be limited to a very small size, such as the ventilation holes described above. A hole of that size would not be large enough to permit a pet owner to insert a hand into the carrier. A further complicating factor that would need to be taken into account is that different pet owners have different sized hands and therefore a hole that is large enough for some pet owners' hands may be too small for other pet owners.

Some pet carriers that are constructed from flexible materials, such as canvas, have one or more openings that may be closed with a zipper or a draw-string. Closing a portal with a zipper or a draw-string, however, will not prevent the animal from escaping when the portal is opened. Although both a zipper and a draw-string can be used to limit the portal to a size that is only slightly larger than the pet owner's hand, the zipper or draw-string could inadvertently be opened too far, allowing the animal to escape from the pet carrier. In addition, a zipper is particularly dangerous for pets with fur because the animal's fur may catch in the zipper when the zipper is closed.

### IV. BRIEF DESCRIPTION OF THE DRAWINGS

A further understanding of the invention can be obtained by reference to embodiments set forth in the illustrations of the accompanying drawings. Although the illustrated embodiments are merely exemplary of systems, methods, and apparatuses for carrying out the invention, both the organization and method of operation of the invention, in general, together with further objectives and advantages thereof, may be more easily understood by reference to the drawings and the following description. Like reference numbers generally refer to like features (e.g., functionally similar and/or structurally similar elements).

The drawings are not necessarily depicted to scale; in some instances, various aspects of the subject matter disclosed herein may be shown exaggerated or enlarged in the drawings to facilitate an understanding of different features. Also, the drawings are not intended to limit the scope of this invention, which is set forth with particularity in the claims as appended hereto or as subsequently amended, but merely to clarify and exemplify the invention.

FIG. 1 depicts an exemplary pet carrier;

FIG. 2 depicts an exploded view of a disc assembly in accordance with the present invention;

FIG. 3 depicts a perspective view of disc assembly in accordance with the present invention;

FIG. 4 depicts a front view of disc assembly in accordance with the present invention;

FIG. 5 depicts an exemplary T-handle;

FIGS. 6A and 6B depict overlapping pieces of fabric in accordance with the present invention;

FIG. 7 depicts a disc secured by a magnet in accordance with the present invention;

FIG. 8 depicts a sliding door installed in a sliding track in accordance with the present invention;

FIG. 9 depicts a mesh panel installed within the borders of a sliding track in accordance with the present invention;

FIG. 10 depicts an opening formed from three pieces of material in accordance with the present invention;

FIGS. 11A and 11B depict a door installed in the interior of a pet carrier in accordance with the present invention;

FIG. 12 depicts a strap protruding from a carrier and attached to a buckle in accordance with the present invention;

FIGS. 13A and 13B depict a sleeve with a drawstring in accordance with the present invention;

FIGS. 14A and 14B depict a sleeve stored on the side of a carrier with a strap in accordance with the present invention;

FIGS. 15A and 15B depict a zippered enclosure in accordance with the present invention.

### V. DETAILED DESCRIPTION OF THE INVENTION

Described below are various structures, techniques and systems for allowing a pet owner to insert a hand into a pet carrier while a pet is located therein, while preventing the pet from escaping the carrier when the pet owner's hand is not in the carrier. The inventions described below may be applied to pet carriers which have a main opening for inserting a pet into, and for removing the pet from, the pet carrier. A second, typically smaller opening is provided to allow the pet owner to reach a hand into the pet carrier. This second opening may be spaced apart from the main opening or may be a smaller discrete portion of the main opening. In addition, further means for preventing a pet from escaping through the second opening may also be provided.

However, the structures, techniques, and systems in accordance with the inventions may be embodied in a wide variety of forms and modes, some of which might be quite different from those in the disclosed embodiments. It will be apparent to a person of ordinary skill in the art that numerous changes may be made to the disclosed embodiments without departing from the spirit and principles of the inventions. Consequently, the specific structural and functional details disclosed herein are merely representative, and are not intended to be limiting or represent an exhaustive enumeration of all aspects of the invention.

A. Rotating Door

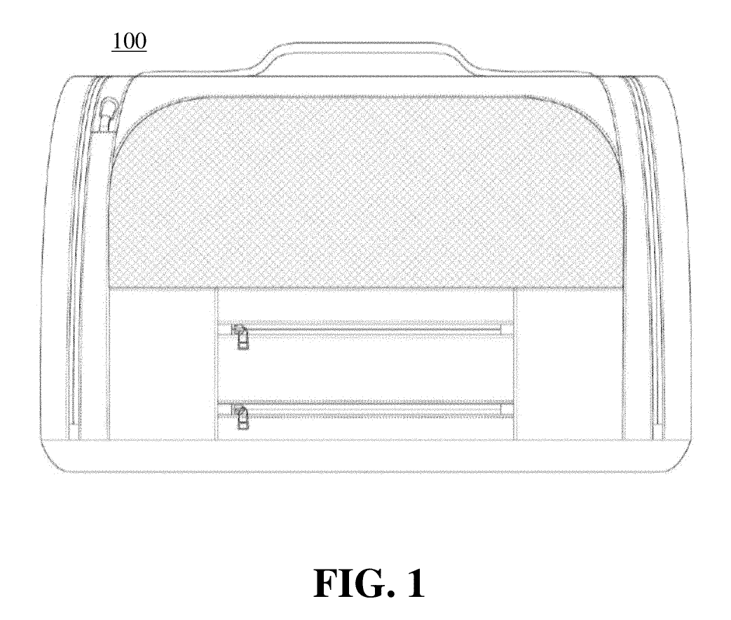

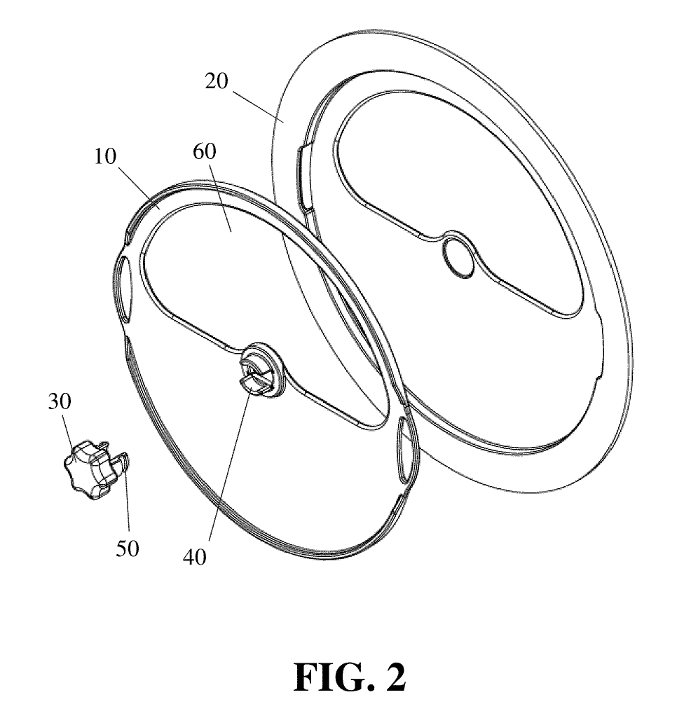

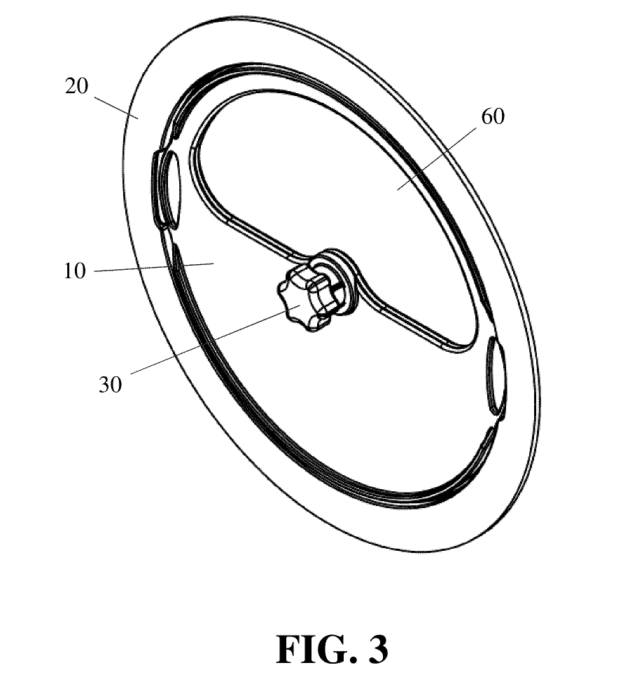

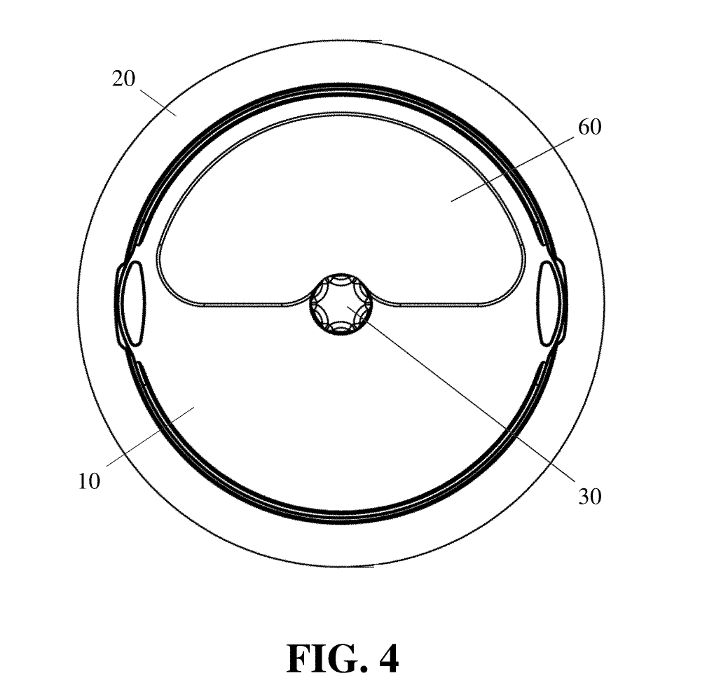

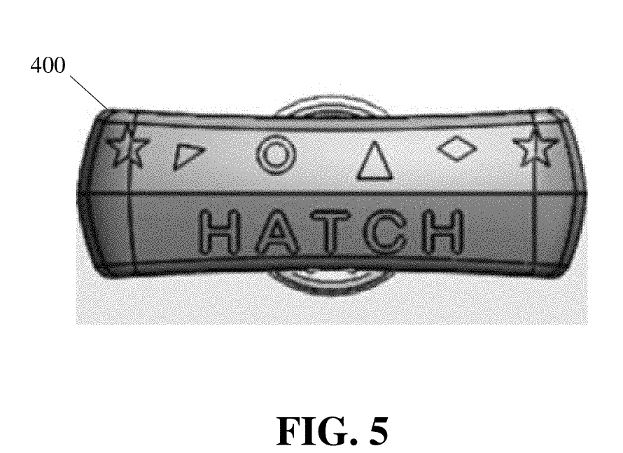

An example of a pet carrier (100) is shown in FIG. 1. FIGS. 2-4 depict a rotatable, circular disc (10) that may be provided at one surface of the carrier (100). The disc is designed to spin about an axis substantially perpendicular to the surface of the disc. Disc (10) may be inserted within a track (20) to facilitate spinning the disc about the axis. This track may be made of plastic or rubber or any other similarly flexible material and may be attached to the interior of the carrier (100). In addition, a knob (30) or similar turning device may be attached to the disc to allow the user to spin the disc. In a preferred embodiment, a T-Handle (400), an example of which is shown in FIG. 5, may be attached to disc (10) to allow the user to spin disc (10). Knob (30) attached to disc (10) would extend beyond the outer surface of the carrier to allow a pet owner to rotate disc (10). Where a T-handle is used, a T-handle attached to the disc would extend beyond the outer surface of the outer layer to allow a pet owner to rotate disc (10).

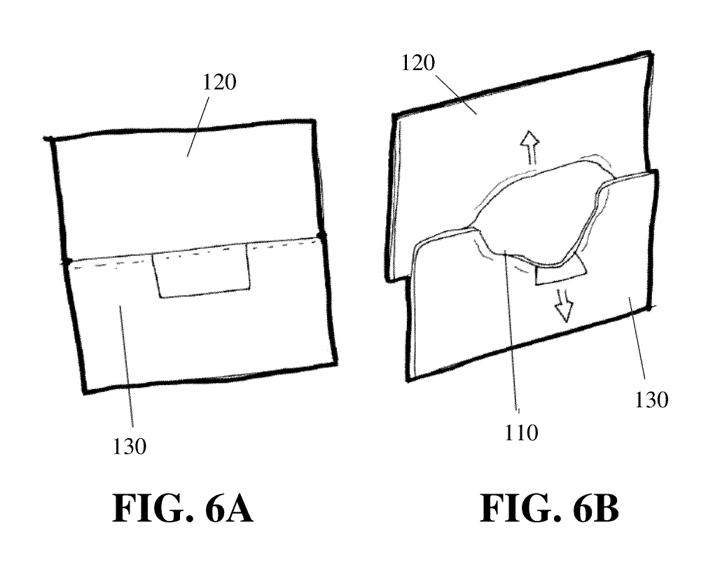

In a preferred embodiment, track (20) would be protected from the animal inside carrier (100) by means of two overlapping pieces of fabric (120, 130) as seen in FIGS. 6A and 6B.

In a preferred embodiment T-handle (400) or knob (30), or similar turning device can screw into raised notches (40) on disc (10), where the raised notches act as a splinth like protrusion that corresponding notches (50) or protrusions on T-handle (400) or knob (30) can screw into to form a connection. In an alternative embodiment, disc (10) may be attached to a more substantial splinth like protrusion that connects to a T-Handle or knob.

In one embodiment, disc (10) has a hole (60) of sufficient size to allow a person to insert a hand there-through. Hole (60) may be of any shape. Disc (10) may be attached to the surface of carrier (100) so as to allow hole (60) of disc (10) to align with the second opening of carrier (100) through which a pet owner may insert a hand. When disc (10) is rotated so as to align hole (60) on disc (10) with the second opening of carrier (100), the pet owner may reach a hand into carrier (100) through the second opening. The second opening may be formed from one or more pieces of flexible material that form a slit opening. The material may be neoprene, rubber, nylon or any other suitable material capable of bending or deforming.

When the pet owner is not reaching into carrier (100), disc (10) may be rotated to a position where hole (60) in disc (10) does not align with the second opening of carrier (100). In that disc position, disc (10) would block the second opening and prevent the pet from escaping carrier (100).

Disc (10) may be attached to the outer surface of carrier (100) so that when disc (10) is rotated, it could not rub against a pet inside carrier (100). In addition, by attaching disc (10) in that manner, the edges of hole (60) of disc (10) could not impinge on the pet. In an alternative, the outer surface of carrier (100) may comprise two layers, and disc (10) may be installed between those two layers. In that arrangement, knob (30) or similar turning device attached to disc (10) would extend beyond the outer surface of the outer layer to allow a pet owner to rotate disc (10). In one embodiment, T-handle (400) attached to disc (10) would extend beyond the outer surface of the outer layer to allow a pet owner to rotate disc (10).

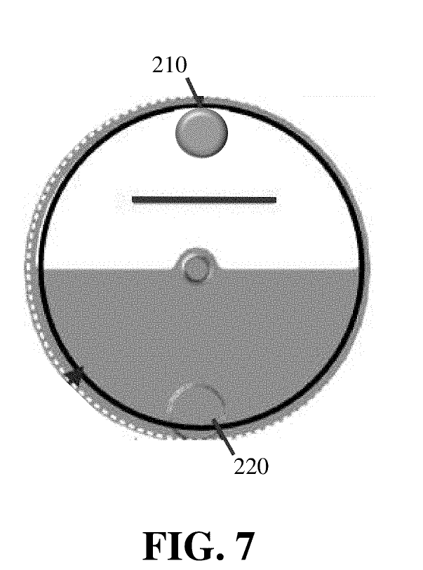

As shown in FIG. 7, a first magnet (210) may be used to secure disc (10) in one or more rotated positions. First magnet (210) may be installed at the surface of carrier (100) at or near the circumference of disc (10). A second magnet (220) or a magnetic metal may be installed on disc (10) in a position whereby the second magnet (220) or magnetic metal may align with first magnet (210) when disc (10) is rotated to a particular position. First magnet (210 could engage second magnet (220) or magnetic metal to temporarily hold disc (10) in place. More than one magnet may be installed at the surface of carrier (100) and/or more than one magnet or magnetic material may be installed on disc (10) to provide a more secure hold or to hold the disc in more than one rotated positions.

In another embodiment, the disc is not a complete circle or is not a circular shape. The disc may be of an unsymmetrical shape whereby the disc would cover the second opening of the carrier when rotated into a first position, but would not cover the second opening when rotated into a second position.

In another embodiment, any of the following examples of doors that cover and uncover the second opening may be combined with an outer door or external covering on the exterior of the carrier that can be used to protect the second opening from the outside or can be used as decorative element that covers the second opening.

B. Sliding Door

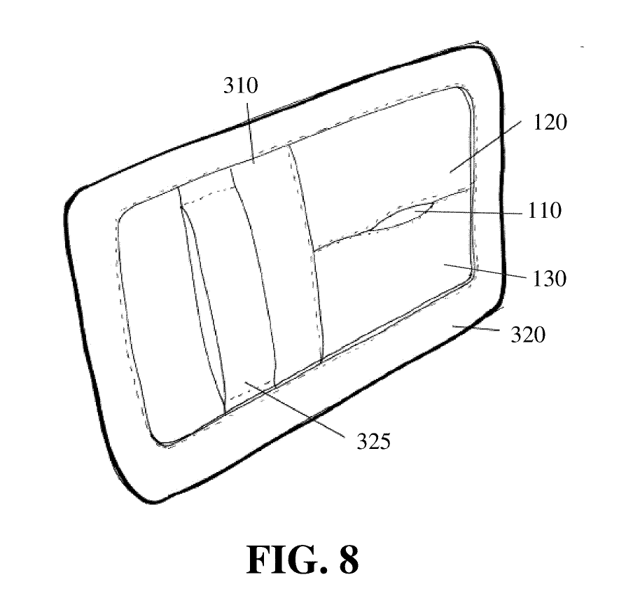

FIG. 8 depicts a sliding door (310) that can be used to practice the invention. The door may be installed on a sliding track (320). This track may be either on the outside of the carrier or inside the carrier, substantially parallel to an interior wall of the carrier. Sliding door (310) can be made of a less flexible material like hard plastic or made from a more flexible, softer material. When the sliding door (310) is slid to one side of the track, the second opening (110) of the carrier is exposed and a pet owner may reach a hand into the carrier. Second opening (110) may be formed from one or more pieces of flexible material that form a slit opening. The material may be neoprene, rubber, nylon or any other suitable material capable of bending or deforming. As depicted in FIG. 8, second opening (110) may be formed from two pieces of flexible material (120, 130) that are adjacent to each other and positioned within sliding track (320). One edge of a first flexible material may be aligned with an edge of the second material to form opening (110) that is closed when no force is applied to the flexible material. However, a pet owner may reach a hand into the carrier by advancing a hand between the two pieces of flexible material (120, 130) where the edges of the flexible material meet.

As shown in FIG. 8, sliding door (310) may be substantially the same size as the flexible material (120, 130). Sliding door (310) may be moved along sliding track (320) in the direction of the flexible material (120, 130) until sliding door (310) substantially covers flexible material (120, 130).

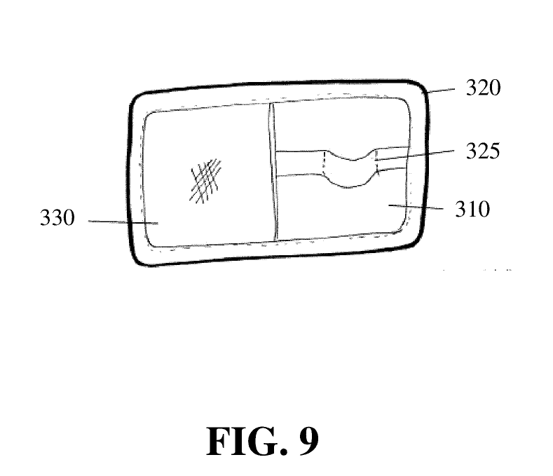

As shown in FIG. 9, a mesh panel (330) may be installed within the borders of sliding track (320), adjacent to the flexible material (120, 130). When sliding door (310) is positioned so as to cover flexible material (120, 130), mesh panel (330) may be uncovered.

Sliding door (310) is depicted in FIGS. 8 and 9 as capable of sliding along a horizontal axis. However, sliding track (320) may also be arranged in a vertical orientation, allowing sliding door (310) to slide in a vertical direction. Sliding track (320) may also be arranged at any angle between horizontal and vertical.

A webbing type handle (325) can be attached to sliding door (310) to facilitate sliding the door into open or closed position. Alternatively, a raised protuberance on the on sliding door (310) or a similar attachment can be used to facilitate sliding the door in the desired direction.

C. Overlapping Flaps

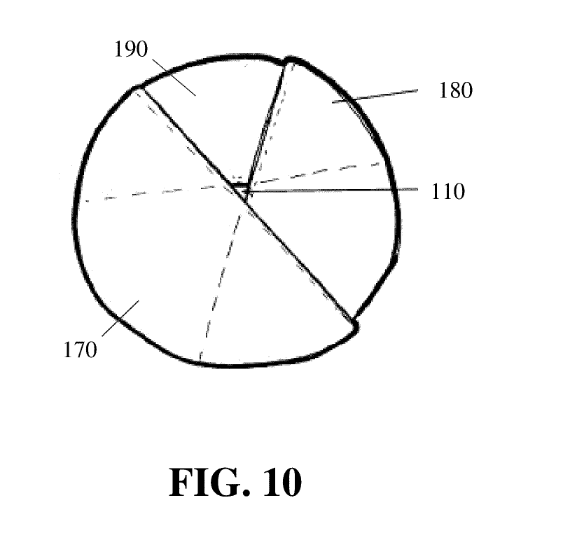

As depicted in FIGS. 6A and 6B, second opening (110) may be formed from pieces of flexible material (120, 130) that are attached to the surface of the carrier (100) and which overlap with each other. The material may be neoprene, rubber, nylon or any other suitable flexible material capable of bending or deforming. The pieces of flexible material (120, 130) may be stretched taught to minimize the amount of space between the pieces. The second opening depicted in FIGS. 6A and 6B is formed from two pieces of rectangular flexible material (120, 130). However, as show in FIG. 10, second opening (110) may be formed from three or more pieces of material (170, 180, 190). Second opening (110) may also be formed from pieces of material that are circular, triangular, or any other suitable shape.

D. Interior Door

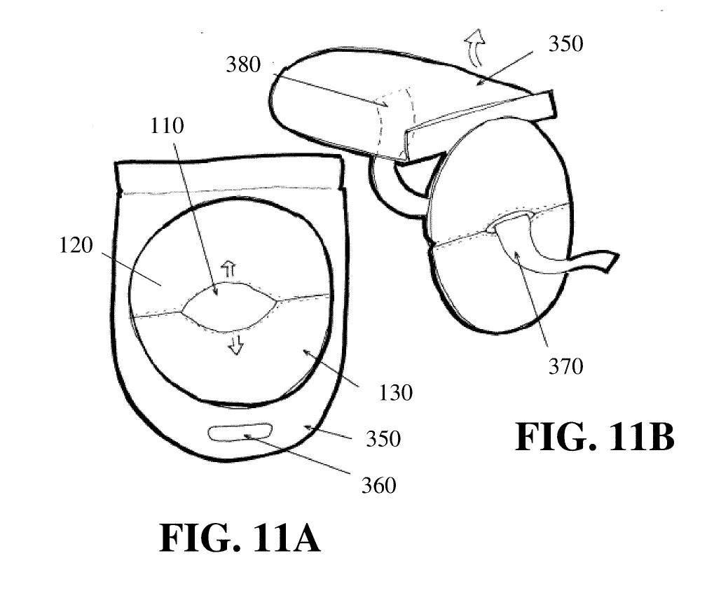

FIGS. 11A and 11B depict a door (350) installed in the interior of a pet carrier. Door (350) may be attached to the interior surface of the carrier and cover second opening (110) when it is in a closed position (see FIG. 11A). Door (350) may be hinged to allow it to rotate away from second opening (110) when a pet owner inserts a hand into the carrier through second opening (110). Second opening (110) may be formed from one or more pieces of flexible material (120, 130) that form a slit opening. The material may be neoprene, rubber, nylon or any other suitable material capable of bending or deforming.

Door (350) may rotate towards the top of the carrier when it is opened. A first magnet (360) may be used to keep door (350) from closing until the pet owner manually closes door (350). First magnet (360) may be installed on door (350), preferably near the edge of door (350) furthest from the hinged side. A second magnet or magnetic metal may be installed on the top surface of the carrier (100). When door (350) is opened, first magnet (360) on door (350) may engage the second magnet or magnetic material on the carrier surface, holding door (350) in place and preventing door (350) from closing. In the alternative, a magnet may be installed on the top surface of carrier (100) and either a magnetic metal may be installed on door (350), or door (350) may be made from a magnetic metal.

In addition, although door (350) has been described as rotating toward the top of carrier (100), door (350) may be designed to rotate in any direction.

As shown in FIG. 11B, a strap (370) may be used to facilitate closing door (350). One end of strap (370) may be attached to door (350), and the other end of strap (370) may protrude through second opening (110) or through another opening in the same wall of carrier (110) as second opening (110) is located. The side of strap (370) protruding from carrier (100) may be used to pull door (350) closed when the pet owner is not reaching inside carrier (100). As the end of strap (370) that protrudes from the carrier is pulled on, it pulls on door (350) by means of the connection point (380) between the other end of strap (370) and door (350).

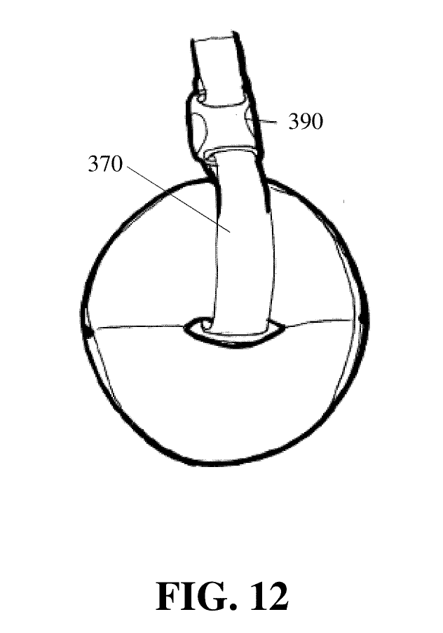

As shown in FIG. 12, the end of strap (370) that protrudes from carrier (100) can be attached to a male buckle part (390) or similar locking mechanism whereby it would latch together with a female buckle part attached to the exterior of carrier (100) to secure strap (370) in place when door (350) is closed. Alternatively, the end of strap (370) that protrudes may be attached to a female buckle or similar part and latch onto a corresponding male part attached to the exterior of carrier (100).

E. Elastic Sleeve

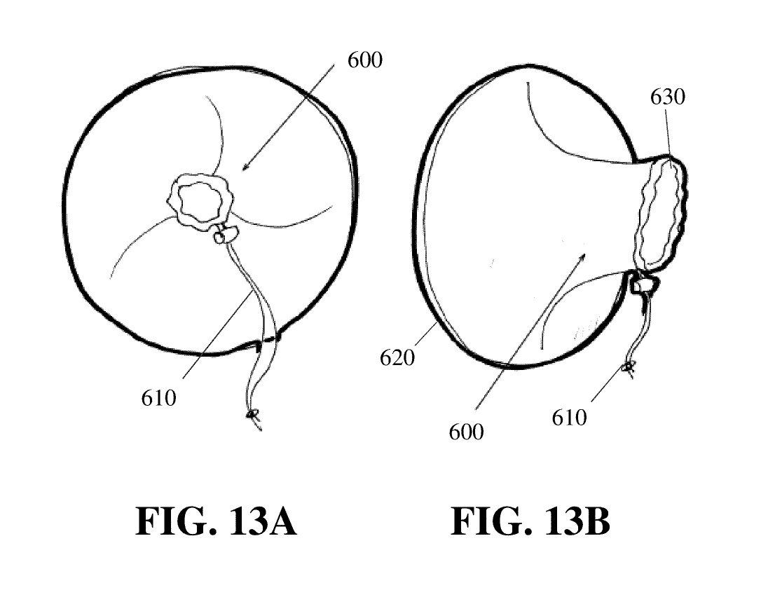

As shown in FIGS. 13A and 13B, a sleeve (600) with a drawstring (610) may be used to provide access to, and seal second opening (110) of carrier (100). The edges (620) of a first opening of sleeve (600) are attached to the surface of the carrier. The second opening (630) of sleeve (600) may be closed completely or substantially by drawstring (610). When a pet owner desires to reach into pet carrier (100), drawstring (610) would be loosened to allow the pet owner to reach a hand through sleeve (600) and into carrier (100).

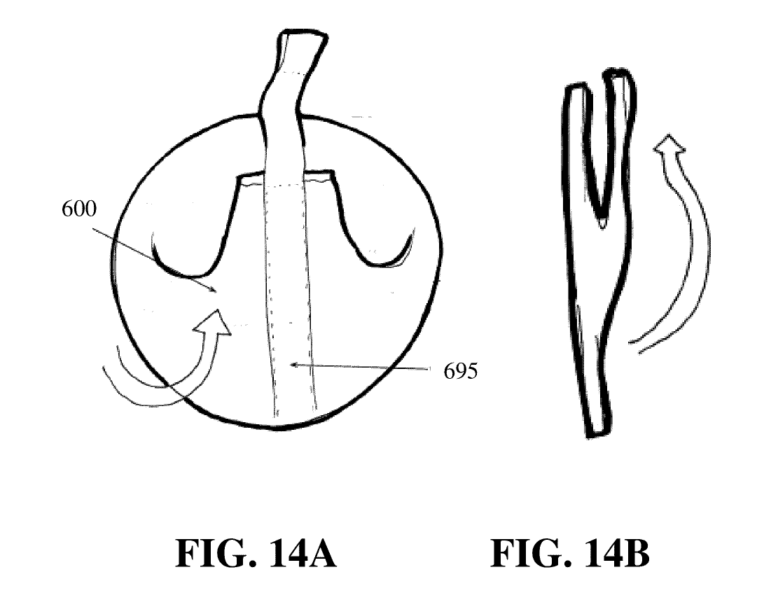

As shown in FIGS. 14A and 14B, sleeve (600) may be stored on the side of carrier (110) with a strap (695). Strap (695) may be attached to the outer surface of sleeve (600), preferably near the edge of sleeve (600) that is attached to the surface of carrier (100). Strap (695) may be attached along the full length of sleeve (600), or attached to a portion of the length of sleeve (600). A portion of strap (695) extending beyond the length of sleeve (600) may be used to fold sleeve (600) across the second opening (110) and attach sleeve (600) to the outer surface of carrier (100).

F. Zippered Enclosure

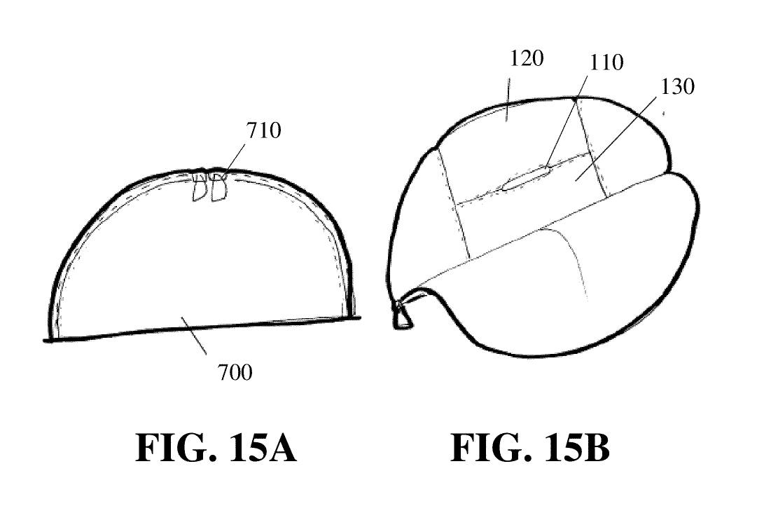

FIGS. 15A and 15B depict a means for sealing and providing access to second opening (110) using a zippered enclosure (700). Enclosure (700) may be positioned adjacent to the outer surface of carrier (100) and cover second opening (110) of carrier (100). Enclosure (700) may be formed from a flexible material, and a zipper (710) may be positioned along the edge of enclosure (700). The pet owner may open zipper (710) and move enclosure (700) away from the surface of carrier (100) to expose second opening (110). Second opening (110) may be formed from one or more pieces of flexible material (120, 130) that form a slit opening. The material may be neoprene, rubber, nylon or any other suitable material capable of bending or deforming.

G. Remote Door

Second opening (110) of carrier (100) may be opened and closed using a remote control similar to a car “key” or TV remote. The remote control can be wired to carrier (100), or wireless. A signal from the remote control unit may activate a rotary motor or linear actuator in the carrier that would rotate or slide the door in the carrier, exposing or covering the second opening. The connection between the motor or linear actuator and the door may be direct or through gears, cables, or strings. The signal may also be used to energize or de-energize an electromagnet that is holding the door in place, to hold the door in place or allow easier movement of the door. The door may rotate into place to cover the opening, as in the case of a rotating disc, or it may slide over the opening.

As an added safety mechanism, there can be a sensor on the rotating or sliding door that communicates with a sensor attached at a point on the second opening. Alternatively, any two sensors that, when connected by infrared or other device bisect the second opening can be used. These sensors may connect via infrared or other means like laser technology. In the instance where these two sensors cannot make uninterrupted contact (the animal or human is blocking the opening), the motor or actuator will not engage and will not cover the opening. This draws from the example of a garage door sensor system where the door closing mechanism cannot be activated if the two infrared eyes do not align.

What is claimed is:

1. A transport container capable of carrying therein a pet animal, comprising:
(a) a housing including a first opening and a second opening, the first opening for inserting an animal into, and for removing the animal from, said housing, the second opening having an interior edge and being spaced apart from the first opening;
(b) an elastic material attached to the housing and physically blocking a substantial portion of the second opening, said elastic material having an aperture therein; and
(c) a disc attached to an outer surface of the housing and capable of rotating about an axis substantially perpendicular to said outer surface, said disc including an opening substantially the same size as the second opening of the housing.
